(19) United States
(12) Patent Application Publication
(10) Pub. No.: US 2005/0229885 A1
(43) Pub. Date: Oct. 20, 2005

(54) Extruded lever for valve timing in a piston engine, and method of making such a lever

(76) Inventors: Reinhard Kick-Rodenbucher, Numberg (DE); Robert Kamm, Veitsbronn (DE); Jens Artmann, Regendorf (DE)

Correspondence Address: HEDMAN & COSTIGAN P.C., 1185 AVENUE OF THE AMERICAS, NEW YORK, NY, 10036, US

(21) Appl. No.: 11/107,051

(22) Filed: Apr. 15, 2005

(30) Foreign Application Priority Data
Apr. 16, 2004 (DE) 10 2004 018 387.2

(51) Int. Cl. F01L 1/18; H01H 13/00; H01H 3/00

(52) U.S. Cl. 123/90.39

(57) ABSTRACT

The invention concerns a method of making a lever for the valve timing of a piston engine, wherein the lever or at least a part of a multi-piece lever (10) is made from a billet-shaped metal section (1) by an extrusion method. The invention further concerns a lever (10) made by this method.

### FIELD OF THE INVENTION

The invention concerns a method of making a lever for valve timing in a piston engine, and further concerns a lever made by this method. This lever can be configured as a one-piece or a multi-piece finger lever.

### BACKGROUND OF THE INVENTION

Various methods of making levers for timing the valves of piston engines are known in the prior art. Such levers can be configured as multi-piece finger levers as shown, for example, in Applicant's patent applications DE 101 55 801 A1 and DE 101 55 825 A1. In these two-piece finger levers, an inner lever is received and pivoted in a reception opening of an outer lever. For their individual activation, the inner and the outer levers comprise contacting surfaces that can enter into operative contact with inner and outer cams of a camshaft. Through a locking device, the inner lever and the outer lever can be coupled mechanically to each other.

Finger levers are made, for example, using casting methods in which, however, the formation of shrinkholes in the region of material accumulations, for instance in regions of larger wall thicknesses, cannot be excluded. Besides this, the surfaces of levers made in this way generally need complex reworking. It is also known to make finger levers out of sheet metal blanks. A drawback of levers thus constructed is that the possibilities of their geometric configuration are restricted.

Thus, for example, the realization of the aforesaid material accumulations is very complex or even impossible. Moreover, in the case of welded two-piece finger levers, a distortion of the component due to the welding process cannot be excluded.

Finally, the documents DE 43 02 781 A1, DE 43 28 375 C2 and U.S. Pat. No. 5,048,475 disclose extrusion methods for making finger levers.

### OBJECTS OF THE INVENTION

It is an object of the invention to provide a method of making a generic-type one-piece or multi-piece lever for the valve timing of a piston engine, as well as to provide a lever made by this method, the material structure of which lever, that has different wall thicknesses and regions of different thicknesses, is free of shrinkholes.

This and other objects and advantages of the invention will become obvious from the following detailed description.

### SUMMARY OF THE INVENTION

The invention is based on the recognition of the fact that a generic-type lever with a structure free of shrinkholes and with different wall thicknesses and regions of different thicknesses can be produced by an extrusion method.

With this method, it is possible to make a one-piece or a multi-piece lever in the form of a rocker arm, a pivoting lever or a finger lever. In a further development of the invention, such a multi-piece lever may be composed of an inner lever and an outer lever, at least one of these lever components being made by the method of the invention.

In one embodiment of the method of the invention, the lever, i.e. the one-piece lever or the at least one lever component of the multi-piece lever is made by the following five method steps:
A) Cutting to length a metal piece out of continuous extruded material.
B) Shaping the rough outer contour of the lever.
C) Forming a reception opening for a pivoting bearing and a reception surface for a hydraulic lash adjuster.
D) Forming a support region for a valve stem.
E) Configuring material accumulations for a locking mechanism for locking the inner and the outer lever to each other.

The continuous extrusion method may be implemented as hot or cold extrusion. In some steps of the method, it is advantageous to use hot shaping and in other steps, cold shaping.

According to a preferred embodiment of the method of the invention, and of a lever made by this method, the lever comprises material accumulations that are made in a controlled manner by extrusion. A material accumulation of this type is configured, for example, at that point of the lever where a locking mechanism for locking the inner and the outer lever is arranged or configured. The locking mechanism may be configured as a piston/cylinder arrangement.

The invention will be described more closely below with reference to one example of embodiment shown in the appended drawings.

### BRIEF DESCRIPTION OF THE DRAWINGS

FIG. 1 shows the manufacturing steps on an inner lever of a switchable finger lever, seen from above, and

FIG. 2 shows the steps of FIG. 1, but as seen from below the inner lever.

### DETAILED DESCRIPTION OF THE DRAWINGS

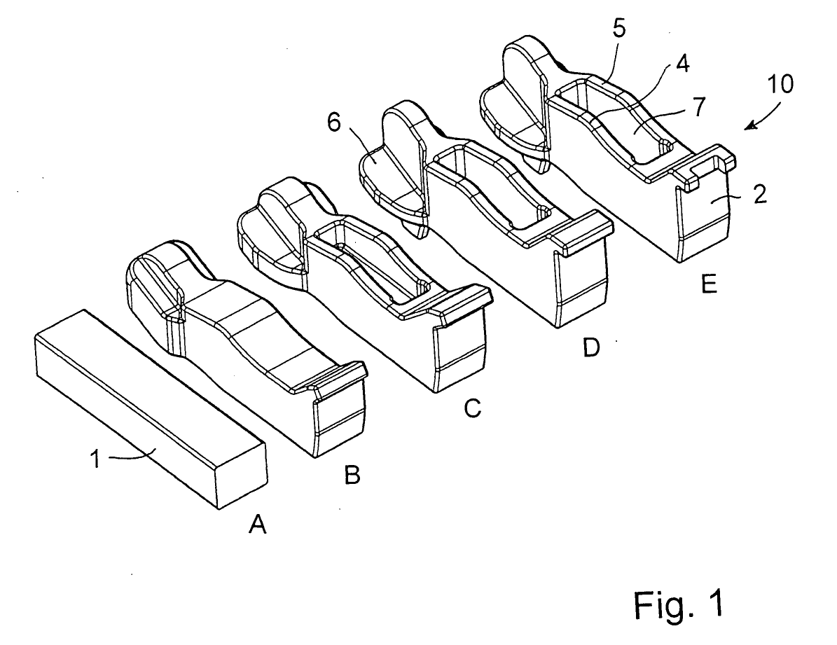

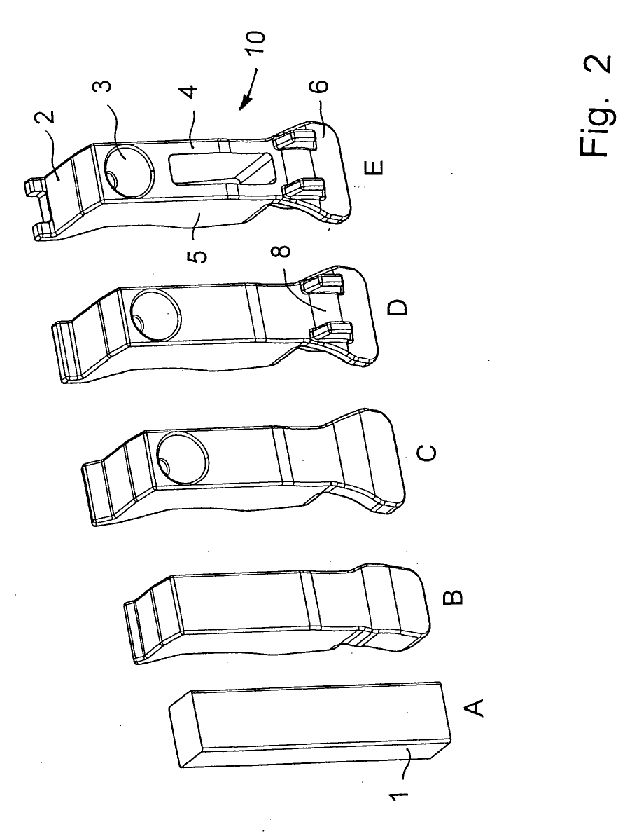

As is clear from the manufacturing steps shown in FIG. 1 and FIG. 2, in a first step A of the method, a substantially beam-shaped metal piece 1 is cut from a continuous extruded metal profile. This metal piece 1 is then placed in an extrusion mold, not shown, and shaped with the help of suitable tools, i.e. dies, in a plurality of steps B to E into a lever. In the present example of embodiment, this lever is an inner lever 10 of a two-piece finger lever for the valve timing of an internal combustion engine.

As the figures show, at first, in a step B of the method, the rough outer contour of the inner lever 10 with its end 2 for the lash adjustor and its end 6 for the valve is formed out of the metal piece 1 that was previously cut to length. In the next step C of the method, are formed, using appropriate tools, the reception opening 7 with the side walls 4 and 5 for a pivoting bearing, and a concave reception surface 3 for a hydraulic lash adjustor. Following this, the support region 8 for the axial end of a valve stem, not shown, is configured in the step D of the method to be followed, finally, by the last extrusion step E in which, at appropriate points of the lever 10, material accumulations are formed, at or in which material accumulations, a locking mechanism for locking together the inner lever 10 and the outer lever is configured in further fabrication steps.

1. A method of making a lever for valve timing in a piston engine, wherein the lever is made of a billet-shaped metal section by an extrusion method.

2. A method of claim 1, wherein a one-piece or a multi-piece lever is made.

3. A method of claim 1, wherein the lever is made as a rocker arm, a pivoting lever or a finger lever.

4. A method of claim 2, wherein the lever is made as a rocker arm, a pivoting lever or a finger lever.

5. A method of claim 3, wherein an inner lever or an outer lever of a two-piece finger lever is made.

6. A method of claim 4, wherein an inner lever or an outer lever of a two-piece finger lever is made.

7. A method of preparing a lever of claim 1, comprising the following five steps:
A) cutting to length a metal piece out of continuous extruded material.
B) Shaping the rough outer contour of the lever.
C) Forming a reception opening with side walls for a pivoting bearing and a reception surface for a hydraulic lash adjuster.
D) Forming a support region for a valve stem and
E) Configuring material accumulations for a locking mechanism for locking the inner and the outer lever to each other.

8. A method of claim 7, wherein manufacturing is performed by at least one of hot shaping and cold shaping.

9. A lever for valve timing in a piston engine, wherein the ever is configured as a finger lever, a pivoting lever, a rocker arm, or as at least an inner lever or an outer lever of a multi-piece lever that is made by an extrusion method.

10. A lever of claim 9, wherein the lever comprises material accumulations that are configured in a controlled manner by the extrusion method.

11. A lever of claim 10, wherein the material accumulations are configured at those points of the lever at which a locking mechanism for locking the inner lever and the outer lever is arranged or configured.
